(19) United States
(12) Patent Application Publication
(10) Pub. No.: US 2026/0267190 A1
(43) Pub. Date: Sep. 10, 2026

(54) DISPLAY APPARATUS

(71) Applicant: SONY SEMICONDUCTOR SOLUTIONS CORPORATION, KANAGAWA (JP)

(72) Inventors: TAKUYA NARUTA, KANAGAWA (JP); HIDETOSHI TOMARI, KUMAMOTO (JP); TAKASHI FUJIMURA, KANAGAWA (JP); TOSHIE KITAMURA, KANAGAWA (JP)

(21) Appl. No.: 19/165,722

(22) PCT Filed: Feb. 15, 2024
(86) PCT No.: PCT/JP2024/005164

§ 371 Date: Sep. 16, 2025

(30) Foreign Application Priority Data
Mar. 24, 2023 (JP) 2023-048874

(51) Int. Cl. G02F 1/1362; G02F 1/1368; H04N 9/31

(52) U.S. Cl. CPC G02F 1/136209; G02F 1/136286; G02F 1/1368; H04N 9/315

(57) ABSTRACT

A first display apparatus of an embodiment of the present disclosure includes: a liquid crystal layer; a first substrate including a plurality of scanning lines and a plurality of signal lines intersecting each other, and a plurality of pixel transistors provided at respective intersecting sections of the plurality of scanning lines and the plurality of signal lines; and a second substrate disposed to be opposed to the first substrate with the liquid crystal layer interposed therebetween, with the second substrate including a first light-blocking section covering at least one of the plurality of scanning lines and the plurality of signal lines in a plan view, and a second light-blocking section covering at least a portion of each of the plurality of pixel transistors, having a substantially rectangular shape, and being wider than the first light-blocking section, in which a slit is provided between the first and second light-blocking sections.

### TECHNICAL FIELD

The present disclosure relates to a display apparatus used as a light valve of a projector, for example.

### BACKGROUND ART

For the purpose of enhancing light resistance and displaying a high-quality image, for example, PTL 1 discloses an electro-optical device including, on a TFT array substrate, a TFT and an upper light-blocking layer that covers at least a channel region of the TFT from an upper side, with an overhang section, which defines a corner cutoff in an opening region of each pixel, being provided in an intersecting region where a data line and a scanning line intersect each other.

### CITATION LIST

### Patent Literature

PTL 1: Japanese Unexamined Patent Application Publication No. JP2003-337553

### SUMMARY OF THE INVENTION

Incidentally, a display apparatus is required to achieve both contrast and light resistance.

It is desirable to provide a display apparatus that makes it possible to improve light resistance without a decrease in contrast.

A first display apparatus according to an embodiment of the present disclosure includes: a liquid crystal layer; a first substrate including a plurality of scanning lines and a plurality of signal lines that intersect each other, and a plurality of pixel transistors provided at respective intersecting sections of the plurality of scanning lines and the plurality of signal lines; and a second substrate disposed to be opposed to the first substrate with the liquid crystal layer interposed therebetween. The second substrate includes a first light-blocking section and a second light-blocking section. The first light-blocking section covers at least one of the plurality of scanning lines and the plurality of signal lines in a plan view. The second light-blocking section covers at least a portion of each of the plurality of pixel transistors, and has a substantially rectangular shape and is wider than the first light-blocking section. A slit is provided between the first light-blocking section and the second light-blocking section.

In the first display apparatus according to an embodiment of the present disclosure, the second substrate, which is disposed to be opposed to the first substrate with the liquid crystal layer interposed therebetween, includes: the first light-blocking section that covers at least one of the plurality of scanning lines and the plurality of signal lines being provided in the first substrate and intersecting each other in a plan view; and the second light-blocking section that covers at least a portion of each of the plurality of pixel transistors being provided at the respective intersecting sections of the plurality of scanning lines and the plurality of signal lines, and that has a substantially rectangular shape and is wider than the first light-blocking section. The slit is further provided between the first light-blocking section and the second light-blocking section. This suppresses blurring at the second light-blocking section in a manufacturing process.

A second display apparatus according to an embodiment of the present disclosure includes: a liquid crystal layer; a first substrate including a plurality of scanning lines and a plurality of signal lines that intersect each other, and a plurality of pixel transistors provided at respective intersecting sections of the plurality of scanning lines and the plurality of signal lines; and a second substrate disposed to be opposed to the first substrate with the liquid crystal layer interposed therebetween. The second substrate includes a first light-blocking section and a second light-blocking section. The first light-blocking section covers at least one of the plurality of scanning lines and the plurality of signal lines in a plan view. The second light-blocking section covers at least a portion of each of the plurality of pixel transistors, and has a substantially rectangular shape and is wider than the first light-blocking section.

In the second display apparatus according to an embodiment of the present disclosure, the second substrate, which is disposed to be opposed to the first substrate with the liquid crystal layer interposed therebetween, includes: the first light-blocking section that covers at least one of the plurality of scanning lines and the plurality of signal lines being provided in the first substrate and intersecting each other in a plan view; and the second light-blocking section that covers at least a portion of each of the plurality of pixel transistors being provided at the respective intersecting sections of the plurality of scanning lines and the plurality of signal lines, and that has a substantially rectangular shape and is wider than the first light-blocking section. This reduces an interaction between the second light-blocking section and polarized light incident on the liquid crystal layer.

### BRIEF DESCRIPTION OF THE DRAWINGS

FIG. 1 is a schematic plan view of an example of a configuration of a liquid crystal display panel according to an embodiment of the present disclosure.

FIG. 2 is a schematic cross-sectional view of an example of the configuration of the liquid crystal display panel illustrated in FIG. 1.

FIG. 3 is a diagram illustrating an example of a configuration of a projection display apparatus including the liquid crystal display panel illustrated in FIG. 1.

FIG. 4 is a diagram illustrating an example of a configuration of a spatial light modulator.

FIG. 5 is a diagram illustrating an example of a circuit configuration of a pixel.

FIG. 6 is a schematic plan view of an example of a configuration of a liquid crystal display panel according to Modification Example 1 of the present disclosure.

FIG. 7 is an explanatory diagram of a shape of a light-blocking section illustrated in FIG. 6.

FIG. 8 is a schematic plan view of an example of a configuration of a liquid crystal display panel according to Modification Example 2 of the present disclosure.

FIG. 9 is a schematic plan view of another example of the configuration of the liquid crystal display panel according to Modification Example 2 of the present disclosure.

FIG. 10 is a schematic plan view of another example of the configuration of the liquid crystal display panel according to Modification Example 2 of the present disclosure.

FIG. 11 is a schematic plan view of another example of the configuration of the liquid crystal display panel according to Modification Example 2 of the present disclosure.

FIG. 12 is a schematic plan view of another example of the configuration of the liquid crystal display panel according to Modification Example 2 of the present disclosure.

FIG. 13 is a schematic plan view of another example of the configuration of the liquid crystal display panel according to Modification Example 2 of the present disclosure.

FIG. 14 is a schematic plan view of another example of the configuration of the liquid crystal display panel according to Modification Example 2 of the present disclosure.

FIG. 15 is a schematic plan view of an example of a configuration of a liquid crystal display panel according to another modification example of the present disclosure.

### MODES FOR CARRYING OUT THE INVENTION

In the following, description is given of embodiments of the present disclosure in detail with reference to the drawings. The following description is merely a specific example of the present disclosure, and the present disclosure should not be limited to the following aspects. Moreover, the present disclosure is not limited to arrangements, dimensions, dimensional ratios, and the like of each component illustrated in the drawings. It is to be noted that the description is given in the following order.
1. Embodiment

(An example of a display apparatus being provided with a slit between a first light-blocking section that covers a scanning line and a signal line and a second light-blocking section that covers a pixel transistor)
2. Modification Examples
   2-1. Modification Example 1 (Another example of a configuration of a liquid crystal display panel)
   2-2. Modification Example 2 (Another example of the configuration of the liquid crystal display panel)
   2-3. Modification Example 3 (Another example of the configuration of the liquid crystal display panel)

### 1. Embodiment

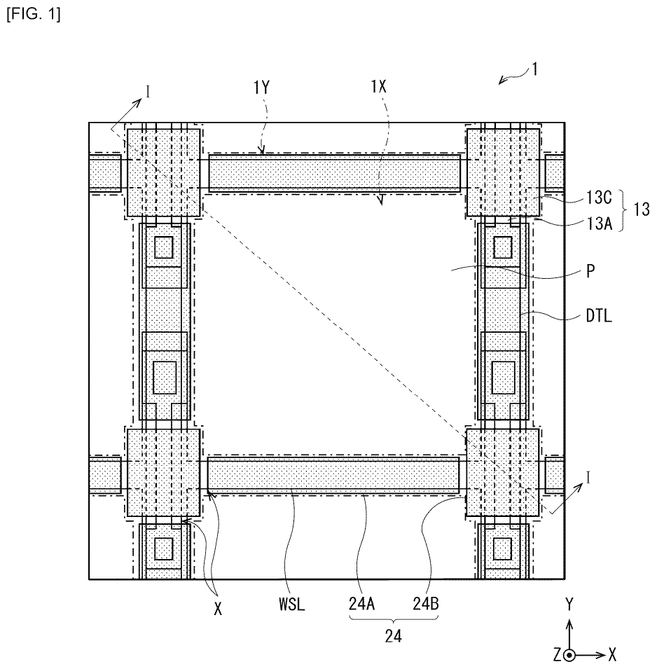

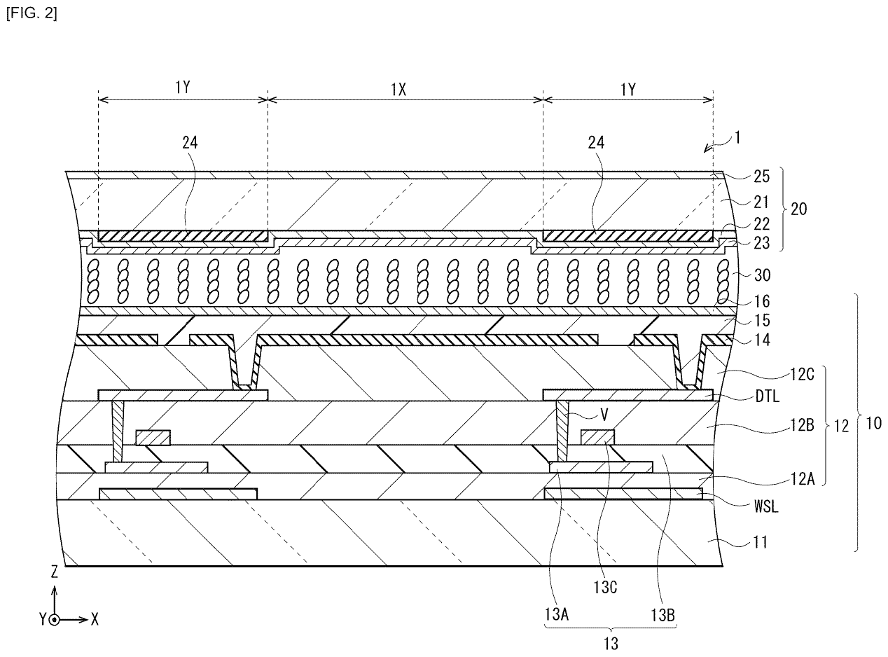

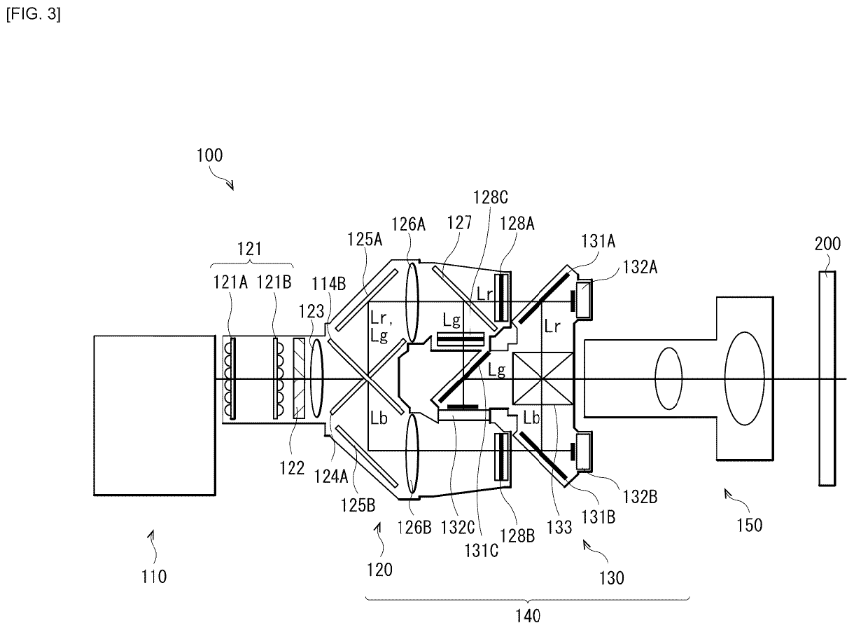

FIG. 1 schematically illustrates an example of a planar configuration of a display apparatus (a liquid crystal display panel 1) according to an embodiment of the present disclosure. FIG. 2 schematically illustrates an example of a cross-sectional configuration of the liquid crystal display panel 1 corresponding to a line I-I illustrated in FIG. 1. The liquid crystal display panel 1 is used, for example, as a light valve (e.g., spatial light modulators 132A, 132B, and 132C) of a projection display apparatus (a projector 100; see FIG. 3), for example, described later.

The liquid crystal display panel 1 includes a display region 1A in which a plurality of pixel P is two-dimensionally arranged in matrix, and a peripheral region 1B provided therearound. The liquid crystal display panel 1 includes a liquid crystal layer 30 between a drive substrate 10 and a counter substrate 20 which are disposed to be opposed to each other. The counter substrate 20 includes a light-blocking section 24 that covers a plurality of scanning lines WSL, a plurality of signal lines DTL, and a plurality of pixel transistors 13. The plurality of scanning lines WSL and the plurality of signal lines DTL, which intersect each other in a plan view, and the plurality of pixel transistors 13 are provided in the drive substrate 10. The plurality of pixel transistors 13 is provided at respective intersecting sections of the plurality of scanning lines WSL and the plurality of signal lines DTL. In the present embodiment, the light-blocking section 24 includes a first light-blocking section 24A and a second light-blocking section 24B. The first light-blocking section 24A is provided along the plurality of scanning lines WSL and the plurality of signal lines DTL, which intersect each other and are provided in the drive substrate 10. The second light-blocking section 24B covers the plurality of pixel transistors 13 being provided at the respective intersecting sections of the plurality of scanning lines WSL and the plurality of signal lines DTL. The second light-blocking section 24B has a rectangular shape, and is wider than the first light-blocking section 24A. A slit X is formed between the first light-blocking section 24A and the second light-blocking section.

### [Configuration of Projector]

FIG. 3 illustrates an example of an overall configuration of the projector 100 including the liquid crystal display panel 1. The projector 100 is, for example, a projection display apparatus of a reflective 3LCD type that performs optical modulation using a reflective liquid crystal display panel (Liquid Crystal Display: LCD).

The projector 100 includes, in order, a light source unit 110, an image optical system 140 including an illumination optical system 120 and an image formation unit 130, and a projection optical system 150.

For example, the illumination optical system 120 includes, from a position close to the light source unit 110, fly-eye lenses 121 (121A and 121B), a polarization conversion element 122, a lens 123, dichroic mirrors 124A and 124B, reflective mirrors 125A and 125B, lenses 126A and 126B, a dichroic mirror 127, and polarizing plates 128A, 128B, and 128C.

The fly-eye lens 121 (121A and 121B) achieves uniformization of an illumination distribution of illumination light from the light source unit 110.

The polarization conversion element 122 functions to align a polarizing axis of incident light in a predetermined direction. For example, randomly polarized light is converted into P-polarized light.

The lens 123 condenses light from the polarization conversion element 122 toward the dichroic mirrors 124A and 124B.

The dichroic mirrors 124A and 124B selectively reflect light of a predetermined wavelength region, and selectively transmit light beams of other wavelength regions. For example, the dichroic mirror 124A mainly reflects red light Lr and green light Lg in a direction of the reflective mirror 125A. In addition, the dichroic mirror 124B mainly reflects blue light Lb in a direction of the reflective mirror 125B.

The reflective mirror 125A reflects the light from the dichroic mirror 124A (mainly the red light Lr and the green light Lg) toward the lens 126A. The reflective mirror 125B reflects the light from the dichroic mirror 124B (mainly the blue light Lb) toward the lens 126B.

The lens 126A transmits the light from the reflective mirror 125A (mainly the red light Lr and the green light Lg), and condenses the transmitted light onto the dichroic mirror 127. The lens 126B transmits the light from the reflective mirror 125B (mainly the blue light Lb), and condenses the transmitted light onto the polarizing plate 128B.

The dichroic mirror 127 selectively reflects the green light Lg toward the polarizing plate 128C, and selectively transmits light beams of other wavelength regions.

The polarizing plates 128A, 128B, and 128C each include a polarizer having a polarizing axis in a predetermined direction. For example, in a case where conversion is made into P-polarized light in the polarization conversion element 122, the polarizing plates 128A, 128B, and 128C transmit P-polarized light, and reflect S-polarized light.

The image formation unit 130 includes reflective polarizing plates 131A, 131B, and 131C, the spatial light modulators 132A, 132B, and 132C, and a dichroic prism 133.

The reflective polarizing plates 131A, 131B, and 131C transmit respective light beams of the same polarizing axes (e.g., P-polarized light) as polarizing axes of polarized light beams from the polarizing plates 128A, 128B, and 128C, and reflect light beams (S-polarized light) of other polarizing axes. Specifically, the reflective polarizing plate 131A transmits the red light Lr of P-polarized light from the polarizing plate 128A in a direction of the spatial light modulator 132A. The reflective polarizing plate 131B transmits the blue light Lb of P-polarized light from the polarizing plate 128B in a direction of the spatial light modulator 132B. The reflective polarizing plate 131C reflects the green light Lg of P-polarized light from the polarizing plate 128C in a direction of the spatial light modulator 132C. In addition, the reflective polarizing plate 131A reflects the red light Lr of S-polarized light from the spatial light modulator 132A to cause the reflected red light Lr to enter the dichroic prism 133. The reflective polarizing plate 131B reflects the blue light Lb of S-polarized light from the spatial light modulator 132B to cause the reflected blue light Lb to enter the dichroic prism 133. The reflective polarizing plate 131C reflects the green light Lg of S-polarized light from the spatial light modulator 132C to cause the reflected green light Lg to enter the dichroic prism 133.

The spatial light modulators 132A, 132B, and 132C perform spatial modulation of the red light Lr, the blue light Lb, and the green light Lg, respectively. The spatial light modulators 132A, 132B, and 132C are each electrically coupled to the signal line DTL that supplies an image signal including image information. The spatial light modulators 132A, 132B, and 132C modulate incident light beams for each pixel on the basis of image signals of respective supplied colors to generate a red image, a green image, and a blue image, respectively.

The dichroic prism 133 combines the incident red light Lr, blue light Lb, and green light Lg, and emits the combined light toward the projection optical system 150.

The projection optical system 150 includes, for example, a plurality of lenses, and the like. The projection optical system 150 expands light emitted from the image formation unit 130 to project the expanded light onto a screen 200 or the like.

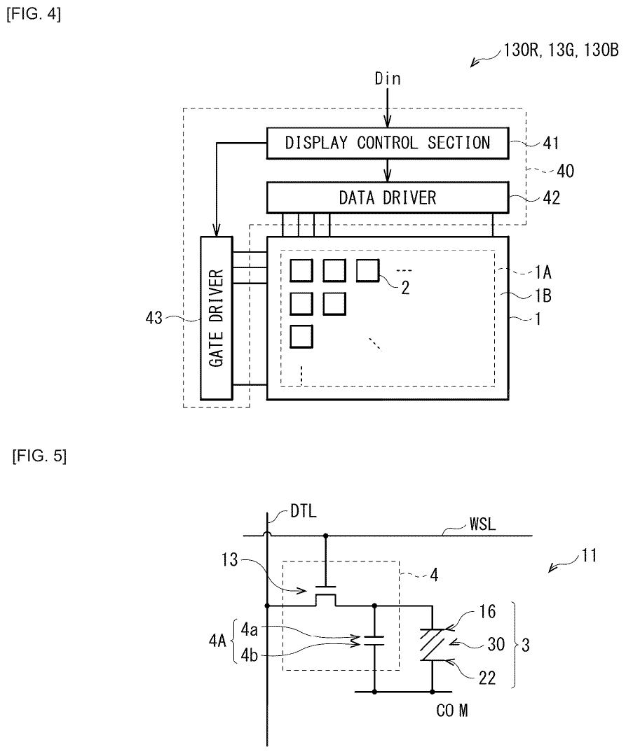

FIG. 4 illustrates an example of an overall configuration of each of the spatial light modulators 132A, 132B, and 132C. The spatial light modulators 132A, 132B, and 132C each include, for example, the liquid crystal display panel 1, and a drive circuit 40 that drives the liquid crystal display panel 1. The drive circuit 40 includes a display control section 41, a data driver 42, and a gate driver 43.

As described above, the liquid crystal display panel 1 includes the display region 1A in which the plurality of pixel P is two-dimensionally arranged in matrix, and the peripheral region 1B. The liquid crystal display panel 1 actively drives each of the pixels P using the data driver 42 and the gate driver 43, thereby displaying an image based on a picture signal Din inputted from the outside.

The liquid crystal display panel 1 includes the plurality of scanning lines WSL extending in a row direction, the plurality of signal lines DTL extending in a column direction, and a plurality of common coupling lines COM present in an extended manner in the row direction or in the column direction. The pixel P is provided in a manner corresponding to the intersecting part of the signal line DTL and the scanning line WSL. Each of the signal lines DTL is coupled to an output end (unillustrated) of the data driver 42. Each of the scanning lines WSL is coupled to an output end (unillustrated) of the gate driver 43. Each of the common coupling lines COM is coupled to, for example, an output end (unillustrated) of a circuit that outputs a fixed potential.

For example, the display control section 41 stores and holds the supplied picture signal Din in a frame memory for each screen (for each display of one frame). For example, the display control section 41 also has a function of controlling the gate driver 43 and the data driver 42 driving the liquid crystal display panel 1 to operate in conjunction with each other. Specifically, for example, the display control section 41 supplies the data driver 42 with a scan timing control signal, and supplies the data driver 42 with a display timing control signal and an image signal of one horizontal line based on an image signal held in the frame memory.

The data driver 42 supplies each of the pixels P with, as a signal voltage, the picture signal Din of one horizontal line supplied from the display control section 41, for example. Specifically, the data driver 42 supplies each of the pixels P, which constitute one horizontal line selected by the gate driver 43, with a signal voltage corresponding to the picture signal Din, for example, via the signal line DTL.

For example, the gate driver 43 has a function of selecting pixels P to be driven in accordance with the scan timing control signal supplied from the display control section 41. Specifically, for example, the gate driver 43 applies a selection pulse, via the scanning line WSL, to a gate electrode 13C of the pixel transistor 13 of the pixel P to thereby select, as a drive target, one row of the pixels P arranged in matrix in the display region 1A. Further, in these pixels P, display of one horizontal line is made in accordance with the signal voltage supplied from the data driver 42. In this manner, for example, the gate driver 43 performs sequential scanning for each horizontal line time-divisionally to perform display across the entire display region.

Next, description is given of a circuit configuration of the pixel P. FIG. 5 illustrates an example of a circuit configuration of the pixel P. The pixel P includes a liquid crystal element 1a and a pixel circuit 50 that drives the liquid crystal element 1a. The liquid crystal element 1a and the pixel circuit 50 are provided in a manner corresponding to the intersecting part of the scanning line WSL and the signal line DTL. The liquid crystal element 1a is configured by the liquid crystal layer 30, and a pixel electrode 14 and a counter electrode 22 that sandwich the liquid crystal layer 30. The pixel circuit 50 is configured by a transistor (pixel transistor 13) that writes a signal voltage into the liquid crystal element 1a, and an accumulation capacitor 51 that holds the voltage written into the liquid crystal element 1a. The accumulation capacitor 51 is configured by a pair of capacitor electrodes opposed to each other with a predetermined gap in between; one capacitor electrode 51A is coupled to a source/drain region of a semiconductor layer 13A, and the other capacitor electrode 51B is coupled to the common coupling line COM.

### [Configuration of Liquid Crystal Display Panel]

As described above, the liquid crystal display panel 1 includes the liquid crystal layer 30 between the drive substrate 10 and the counter substrate 20 which are disposed to be opposed to each other. The drive substrate 10 includes the plurality of scanning lines WSL and the plurality of signal lines DTL intersecting each other and extending in an X-axis direction and a Y-axis direction, respectively, for example. The drive substrate 10 includes an opening region 1X that reflects or transmits incident light, and a non-opening region 1Y provided around the opening region 1X. This non-opening region 1Y is provided with the plurality of scanning lines WSL and the plurality of signal lines DTL intersecting each other and with the pixel transistor 13. As described above, the counter substrate 20 includes the light-blocking section 24 that covers the plurality of scanning lines WSL, the plurality of signal lines DTL, and the plurality of pixel transistors 13. The plurality of scanning lines WSL and the plurality of signal lines DTL, which intersect each other, in a plan view, and the plurality of pixel transistors 13 are provided in the drive substrate 10. The plurality of pixel transistors 13 is provided at respective intersecting sections of the plurality of scanning lines WSL and the plurality of signal lines DTL.

The drive substrate 10 includes, for example, a support substrate 11 including silicon (Si), an interlayer insulating layer 12 including the scanning line WSL, the signal line DTL, and the pixel transistor 13, the pixel electrode 14, a planarization layer 15, and an orientation film 16.

The scanning line WSL extends in the X-axis direction, for example, and is present partially in an extended manner in the Y-axis direction. Specifically, the scanning line WSL is present in an extended manner immediately below (opposed region) an LDD region of the pixel transistor 13 and in a periphery thereof, with an insulating film 12A interposed therebetween. The scanning line WSL is formed by, for example, a metal film of tungsten (W), titanium (Ti), molybdenum (Mo), chromium (Cr), tantalum (Ta), or the like, or an alloy film thereof.

The signal line DTL extends in the Y-axis direction, for example, and is provided immediately above the semiconductor layer 13A, for example, with a gate insulating film 13B and an insulating film 12B interposed therebetween. In the source/drain region of the semiconductor layer 13A, the signal line DTL is electrically coupled to the semiconductor layer 13A through a via V that penetrates the gate insulating film 13B and the insulating film 12B.

The interlayer insulating layer 12 includes, for example: the insulating film 12A provided on the support substrate 11 and covering the plurality of scanning lines WSL; the insulating film 12B provided on the gate insulating film 13B and covering the gate electrode 13C; and an insulating film 12C provided on the insulating film 12B and covering the plurality of signal lines DTL. The interlayer insulating layer 12 is formed by, for example, silicon oxide (SiO₂), silicon nitride (Si₃N₄), silicon oxynitride (SiON), SiCN, or the like.

The pixel transistor 13 has an LDD (Lightly Doped Drain) structure, for example. The pixel transistor 13 includes the semiconductor layer 13A, the gate electrode 13C that applies an electric field to a channel region of the semiconductor layer 13A, and the gate insulating film 13B that insulates and isolates the semiconductor layer 13A and the gate electrode 13C from each other. The semiconductor layer 13A includes the channel region at a position opposed to the gate electrode 13C. The semiconductor layer 13A further includes the LDD region provided on both sides of the channel region, and the source/drain region each further provided outside the LDD region. The gate electrode 13C is electrically coupled to the scanning line WSL, one of the source/drain region of the semiconductor layer 13A is electrically coupled to the signal line DTL, and the other of the source/drain region is electrically coupled to the pixel electrode 14.

The semiconductor layer 13A is configured by, for example, an amorphous silicon film, a polycrystalline silicon film, or the like. In a case where the semiconductor layer 13A is formed by a polycrystalline silicon film, the source/drain region is doped with impurities such as n-type impurities, for example, and has decreased resistance. The LDD region is doped with impurities to have a lower impurity concentration than that of the source/drain region.

The gate insulating film 13B is used to electrically insulate the semiconductor layer 13A and the gate electrode 13C from each other. The gate insulating film 13B is formed by, for example, silicon oxide (SiO₂), silicon nitride (Si₃N₄), or the like, and may be formed by a thermal oxidation method or a chemical vapor deposition (CVD) method, for example.

The gate electrode 13C is provided to straddle the semiconductor layer 13A in the X-axis direction, with the gate insulating film 13B interposed therebetween. In the semiconductor layer 13A, a region opposed to the gate electrode 13C is a channel region. The gate electrode 13C is formed by a material having electrical conductivity. Specifically, the gate electrode 13C is formed by, for example, an amorphous silicon film, a polycrystalline silicon film, or a metal film of W, Ti, Mo, Cr, Ta, or the like, or an alloy film thereof. In addition thereto, the gate electrode 13C may be a stacked film in which an electrically-conductive film formed by a material having electrical conductivity such as polysilicon or amorphous silicon and a metal film selected from those mentioned above are stacked.

It is to be noted that there is exemplified, as the pixel transistor 13 of the present embodiment, the semiconductor layer 13A being present in an extended manner in the Y-axis direction; however, this is not limitative. The semiconductor layer 13A may be present in an extended manner in the X-axis direction. In a case where the signal line DTL extends in the Y-axis direction as in the present embodiment, however, causing the semiconductor layer 13A to be present in an extended manner in the Y-axis direction is superior in terms of layout efficiency.

The pixel electrode 14 is provided for each of the pixels P, and is formed by, for example, a metal material having light reflectivity and mainly including a low-resistance metal. Examples of the metal material include aluminum (Al), titanium (Ti), copper (Cu), silicon (Si), silver (Ag), or an alloy thereof (e.g., an Al-Cu alloy or an Al-Si alloy). The pixel electrodes 14 each have, for example, a substantially rectangular shape, and are arranged in matrix in the display region 1A. The pixel electrode 14 has a film thickness (hereinafter, simply referred to as a thickness) in a Z-axis direction of 50 nm or more and 2000 nm or less, for example.

It is to be noted that, in a case of constituting a liquid crystal display panel of a transmissive type, the pixel electrode 14 includes a transparent electrically-conductive film, for example. Examples of a material of the transparent electrically-conductive film include oxide semiconductors called indium tin oxide (ITO), indium zinc oxide (IZO), zinc oxide (ZnO), and IGZO (indium-gallium-zinc-containing oxide).

The planarization layer 15 is used to planarize a surface of the drive substrate 10 opposed to the liquid crystal layer 30. The planarization layer 15 is formed by, for example, silicon oxide (SiO₂), silicon nitride (Si₃N₄), silicon oxynitride (SiON), SiCN, or the like.

The orientation film 16 controls orientation of the liquid crystal layer 30, and is configured by, for example, an inorganic material such as silicon oxide (SiO₂), diamond-like carbon, or aluminum oxide (Al₂O₃). The orientation film 16 may be formed using, for example, a vapor deposition method.

The counter substrate 20 includes, for example, a support substrate 21 having light transmissivity, the counter electrode 22, an orientation film 23, the light-blocking section 24, and a polarizing plate 25. The counter electrode 22, the orientation film 23, and the light-blocking section 24 are provided on a side of a surface of the support substrate 21 opposed to the liquid crystal layer 30, and the polarizing plate 25 is provided on a surface of the support substrate 21 on a side opposite to the surface opposed to the liquid crystal layer 30.

The counter electrode 22 is provided, for example, as a common electrode to all the pixels P, across the entire surface of the display region 1A. The counter electrode 22 is configured by, for example, an electrically-conductive material having light transmissivity. Examples of the electrically-conductive material having light transmissivity include indium tin oxide (ITO), indium zinc oxide (IZO), zinc oxide (ZnO), and indium-gallium-zinc-containing oxide (IGZO).

The orientation film 23 controls orientation of the liquid crystal layer 30, and is configured by, for example, an inorganic material such as silicon oxide (SiO₂), diamond-like carbon, or aluminum oxide (Al₂O₃). The orientation film 23 has a thickness of 50 nm or more and 500 nm or less, for example. The orientation film 16 may be formed using, for example, a vapor deposition method.

The light-blocking section 24 is used to reduce irradiation of light incident from a side of the counter substrate 20 on the plurality of scanning lines WSL and the plurality of signal lines DTL as well as on the plurality of pixel transistors 13 disposed at respective intersecting sections thereof. The light-blocking section 24 is provided between the support substrate 21 and the counter electrode 22, and includes the first light-blocking section 24A and the second light-blocking section 24B having a rectangular shape and being wider than the first light-blocking section 24A.

The first light-blocking section 24A is used to prevent the irradiation of light on the plurality of scanning lines WSL and the plurality of signal lines DTL. The second light-blocking section 24B is provided, in a plan view, above each of the plurality of scanning lines WSL and the plurality of signal lines DTL.

The second light-blocking section 24B is used to prevent irradiation of light on the plurality of pixel transistors 13 provided at the respective intersecting sections of the plurality of scanning lines WSL and the plurality of signal lines DTL. The second light-blocking section 24B is provided, in a plan view, above the pixel transistor 13 to cover the entire formation region of the pixel transistor 13. Specifically, the second light-blocking section 24B is coincident with the formation region of the pixel transistor 13.

The slit X is formed between the first light-blocking section 24A and the second light-blocking section 24B. The slit X separates the first light-blocking section 24A and the second light-blocking section 24B from each other. The light-blocking section 24 including the first light-blocking section 24A and the second light-blocking section 24B may be formed as follows: a light-blocking film is formed on the support substrate 21 across the entire surface of the display region 1A using a CVD method, for example, and then photolithography and etching are used to pattern the light-blocking film. In the present embodiment, the light-blocking film is exposed and etched using a photomask having a slit of 0.5 μm or more and with a pitch of ⅓ or less of a pixel pitch, for example, between a pattern defining the first light-blocking section 24A and a pattern defining the second light-blocking section 24B. This suppresses a blurred pattern at a boundary part, where widths change, between the first light-blocking section 24A and the second light-blocking section 24B. This allows for formation of the slit X between the first light-blocking section 24A and the second light-blocking section 24B.

The light-blocking section 24 including the first light-blocking section 24A and the second light-blocking section 24B is formed by a material having a light-blocking property. Specific examples of the material include tungsten (W), molybdenum (Mo), titanium (Ti), aluminum (Al), and copper (Cu).

The polarizing plate 25 is arranged in crossed Nicols, for example, thus enabling only light (polarized light) in a predetermined oscillation direction to pass through the polarizing plate. Each polarizing plate is configured by, for example, polyvinyl alcohol (PVA) in which iodine (I) compound molecules are adsorbed and oriented.

The liquid crystal layer 30 is configured by a liquid crystal to be driven by, for example, a VA (Vertical Alignment) mode, a TN (Twisted Nematic) mode, an ECB (Electrically controlled birefringence) mode, an FFS (Fringe Field Switching) mode, an IPS (In Plane Switching) mode, or another mode. The liquid crystal layer 30 is sealed by a thermosetting or UV curable sealant which is commercially available for a liquid crystal display, for example, and which adheres the drive substrate 10 and the counter substrate 20 together. After the drive substrate 10 and the counter substrate 20 are adhered together by the sealant, the liquid crystal layer 30 is injected with a liquid crystal and sealed with a UV curable sealant, for example. Alternatively, the liquid crystal layer 30 may be fabricated using an ODF (One Drop Fill) process, for example. A plurality of pixel electrodes 14 and the counter electrode 22 supply the liquid crystal layer 30 with a picture voltage.

### [Workings and Effects]

The liquid crystal display panel 1 of the present embodiment is provided with the first light-blocking section 24A and the second light-blocking section 24B. The first light-blocking section 24A covers the plurality of scanning lines WSL and the plurality of signal lines DTL provided in the drive substrate 10 and intersecting each other in a plan view. The second light-blocking section 24B covers the plurality of pixel transistors 13 disposed at the respective intersecting sections of the plurality of scanning lines WSL and the plurality of signal lines DTL. The second light-blocking section 24B has a rectangular shape, and is wider than the first light-blocking section 24A. Further, the slit X is provided between the first light-blocking section 24A and the second light-blocking section 24B. This reduces an interaction between the second light-blocking section and polarized light incident on the liquid crystal layer. This is described below.

There is a demand for higher luminance of a liquid crystal display panel; in order to achieve the higher luminance, the liquid crystal display panel is required to have an improved opening rate of a pixel. Meanwhile, a liquid crystal display panel used as a light modulation device (light valve) of a projection display apparatus is required to have improved light-blocking performance (light resistance) for a pixel transistor, in order to prevent generation of a leak current due to strong light from a light source as well as degradation of image quality such as flicker.

For the purpose of achieving both the opening rate and the light resistance, it has been proposed, in a typical liquid crystal display panel, to provide, on a TFT array substrate, a light-blocking layer including an overhang section that defines a corner cutoff in an opening region of each pixel to cover a TFT and at least a channel region of the TFT at an intersecting region where a data line and a scanning line intersect each other, as described above. However, in a case where the overhang section is provided at the intersecting section between the data line and the scanning line, there is an issue of a decrease in contrast caused by a blurred pattern of the overhang section despite improved light resistance.

In contrast, in the present embodiment, the slit X is formed between the first light-blocking section 24A and the second light-blocking section 24B to separate the first light-blocking section 24A and the second light-blocking section 24B from each other. The first light-blocking section 24A covers the plurality of scanning lines WSL and the plurality of signal lines DTL intersecting each other. The second light-blocking section 24B covers the plurality of pixel transistors 13 disposed at the respective intersecting sections of the plurality of scanning lines WSL and the plurality of signal lines DTL. The second light-blocking section 24B has a rectangular shape, and is wider than the first light-blocking section 24A. The slit X is derived from a pattern of the photomask used in forming the first light-blocking section 24A and the second light-blocking section 24B. In the photomask, there is formed a slit of 0.5 μm or more and with a pitch of ⅓ or less of a pixel pitch, for example, between a mask defining the first light-blocking section 24A and a mask defining the second light-blocking section 24B. This suppresses a blurred pattern at a boundary part, where widths change, between the first light-blocking section 24A and the second light-blocking section 24B.

As described above, it is possible, in the liquid crystal display panel 1 of the present embodiment, to improve light resistance without a decrease in the contrast.

Next, description is given of Modification Examples 1 to 3 of the present disclosure. It is to be noted that components similar to the components of the liquid crystal display panel 1 in the foregoing embodiment are denoted by the same reference numerals and descriptions thereof are omitted as appropriate.

### 2. Modification Examples

### (2-1. Modification Example 1)

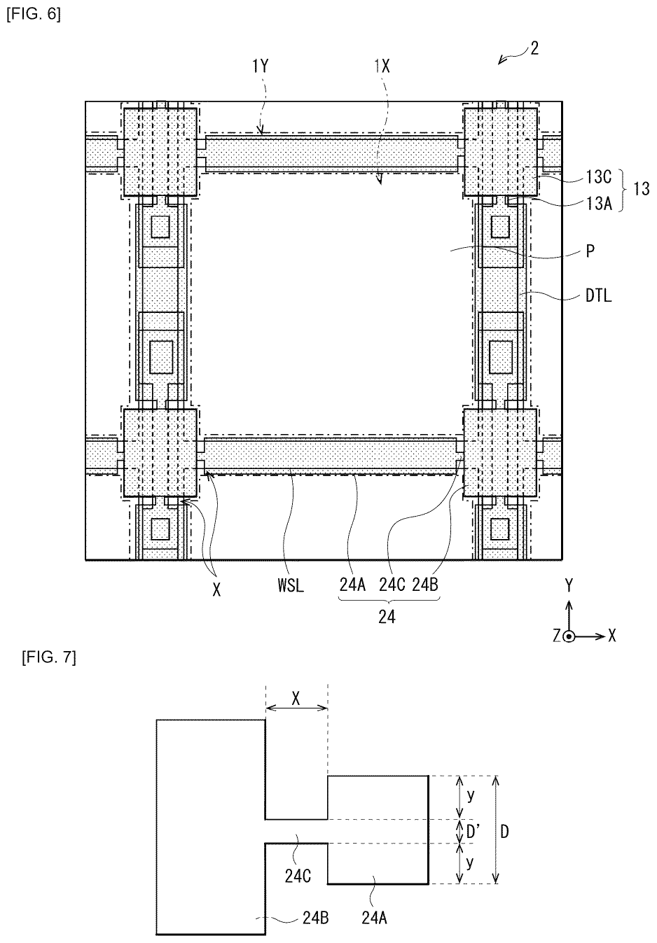

FIG. 6 schematically illustrates an example of a planar configuration of a display apparatus (a liquid crystal display panel 2) according to Modification Example 1 of the present disclosure.

The foregoing embodiment exemplifies the first light-blocking section 24A and the second light-blocking section 24B being completely separated from each other by the slit X; however, this is not limitative. In the liquid crystal display panel 2 of the present modification example, the first light-blocking section 24A and the second light-blocking section 24B are coupled to each other by a coupling section 24C.

The coupling section 24C couples the first light-blocking section 24A and the second light-blocking section 24B to each other. The coupling section 24C has a configuration as illustrated in FIG. 7, for example. Specifically, a width D′ of the coupling section 24C is preferably less than ½ of a width D of the first light-blocking section 24A (D′<½D). In addition, in a case where the first light-blocking section 24A and the second light-blocking section 24B are coupled to each other by the coupling section 24C, a width x of a slit C is preferably larger than ¼ of the width D of the first light-blocking section 24A (x>¼D). Further, the coupling section 24C is preferably formed at substantially the middle of the width of the first light-blocking section 24A, and a width y of the first light-blocking section 24A on both sides of the coupling section 24C is preferably larger than ¼ of the width D of the first light-blocking section 24A (y>¼D). This enables the first light-blocking section 24A and the second light-blocking section 24B to be coupled to each other while suppressing a blurred pattern at the boundary part, where the widths change, between the first light-blocking section 24A and the second light-blocking section 24B.

As described above, in the liquid crystal display panel 2 of the present modification example, the first light-blocking section 24A and the second light-blocking section 24B are coupled to each other by the coupling section 24C. This enables formation of a thermally conductive path between the first light-blocking section 24A and the second light-blocking section 24B. It is therefore possible to improve heat dissipation performance in the light-blocking section 24, for example, in addition to the effects of the foregoing embodiment. For example, it is possible, in the projector 100, to reduce a temperature rise for heat generated by light irradiated from the light source unit 110.

### (2-2. Modification Example 2)

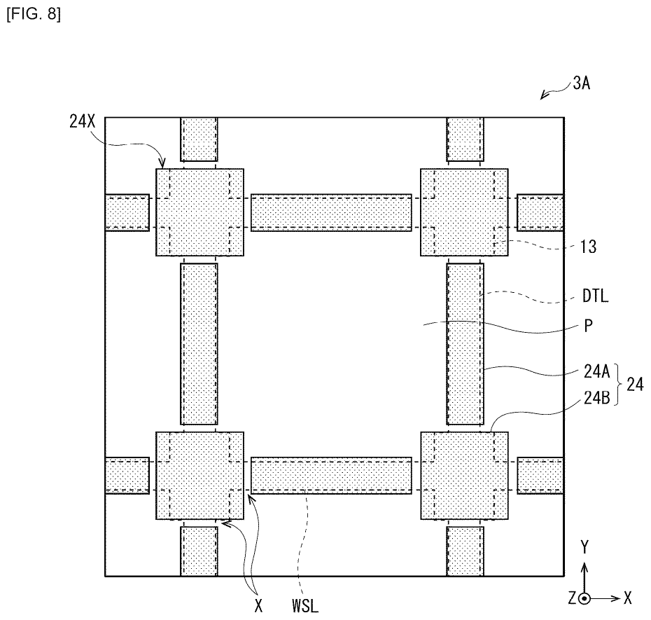

FIGS. 8 to 14 schematically illustrate examples of planar configurations of display apparatuses (liquid crystal display panels 3A to 3G) according to Modification Example 2 of the present disclosure. The first light-blocking section 24A and the second light-blocking section 24B may be patterned as follows.

For example, as in the liquid crystal display panel 3A illustrated in FIG. 8, the second light-blocking section 24B may overhang (an overhang section 24X), in a plan view, in an extending direction of the plurality of scanning lines WSL (e.g., the X-axis direction) or in an extending direction of the plurality of signal lines DTL (e.g., the Y-axis direction).

In the liquid crystal display panel (e.g., the liquid crystal display panel 1), a spacer is appropriately disposed at the intersecting section between the scanning line WSL and the signal line DTL, for example, in order to maintain a thickness (gap) of the liquid crystal layer 30. The spacer has, on a surface, active species having radical polymerization initiation ability, for example. The orientation films 16 and 23 are also formed on a side surface of the spacer, thereby making it possible to suppress degradation of liquid crystal molecules due to a radical reaction initiated when the spacer is irradiated with light. However, the orientation films 16 and 23 on the side surface of the spacer may not be formed at a shaded part in a direction of the deposition in some cases. Therefore, causing the second light-blocking section 24B to be present in an extended manner in the shaded direction makes it possible to suppress the radical reaction of the spacer and thus to suppress degradation of liquid crystal elements. This makes it possible to improve reliability.

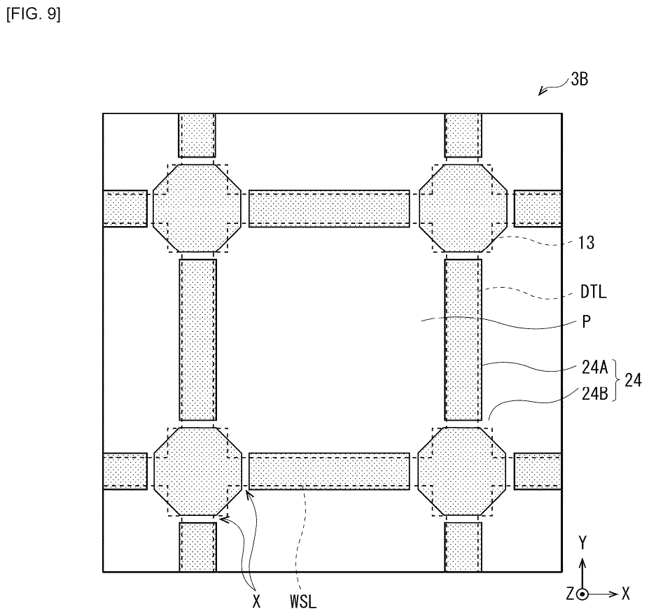

For example, the second light-blocking section 24B may have a polygonal (e.g., octagonal) shape other than the rectangular shape, as in the liquid crystal display panel 3B illustrated in FIG. 9. Also in a case where the second light-blocking section 24B has a polygonal shape other than the rectangular shape, the formation of the slit X between the light-blocking section 24A and the second light-blocking section 24B suppresses the blurred pattern of the second light-blocking section 24B, thus making it possible to improve the light resistance while suppressing a decrease in the contrast.

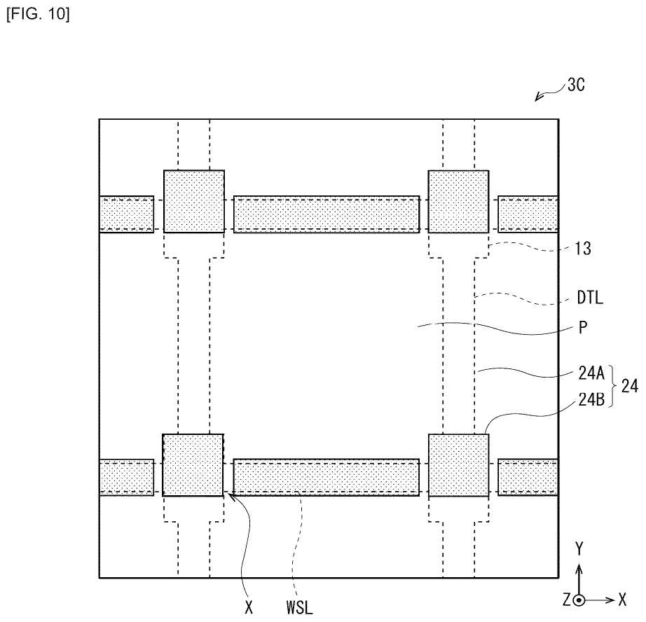

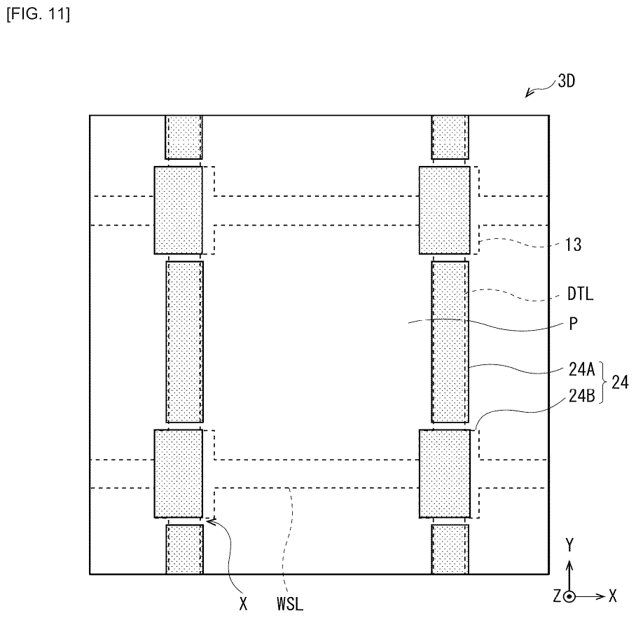

For example, the first light-blocking section 24A may be formed only above one of the plurality of scanning lines WSL and the plurality of signal lines DTL intersecting each other, as in the liquid crystal display panels 3C and 3D illustrated in FIGS. 10 and 11. In addition, the second light-blocking section 24B may be formed to cover only a portion of the formation region of the pixel transistor 13, for example, as in the liquid crystal display panels 3C and 3D illustrated in FIGS. 10 and 11. As described above, also in a case where the light-blocking section 24 is formed in the plurality of scanning lines WSL, the plurality of signal lines DTL, and only a portion of the formation region of the pixel transistor 13, it is possible to obtain constant light resistance without a decrease in the contrast.

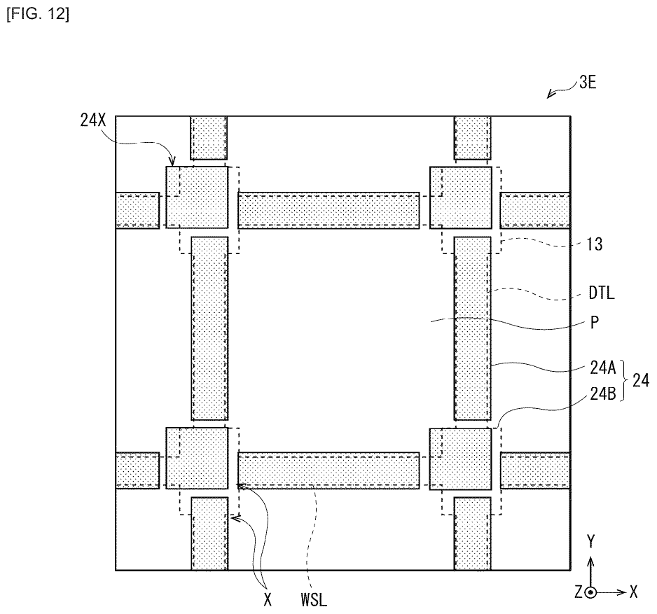

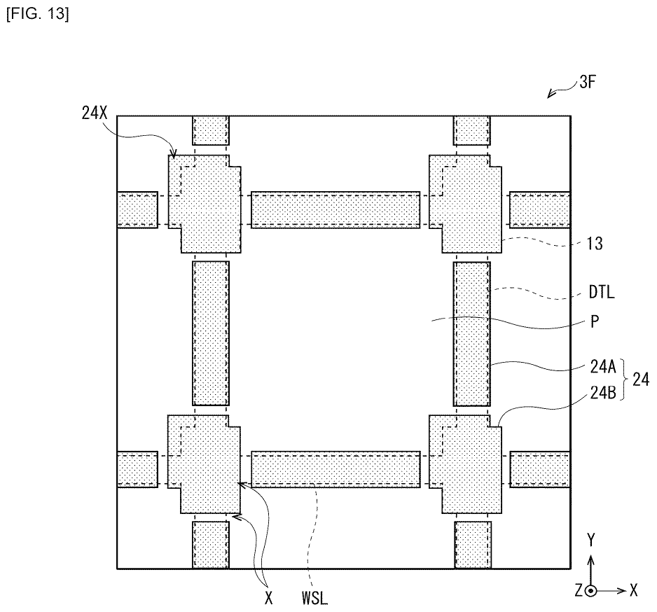

For example, the overhang section 24X may be formed only in a portion of the second light-blocking section 24B, as in the liquid crystal display panels 3E and 3F illustrated in FIGS. 12 and 13. Specifically, the overhang section 24X may be formed selectively only in the shaded part of the above-described spacer in the direction of the deposition. This makes it possible to improve the reliability in the same manner as the liquid crystal display panel 3A.

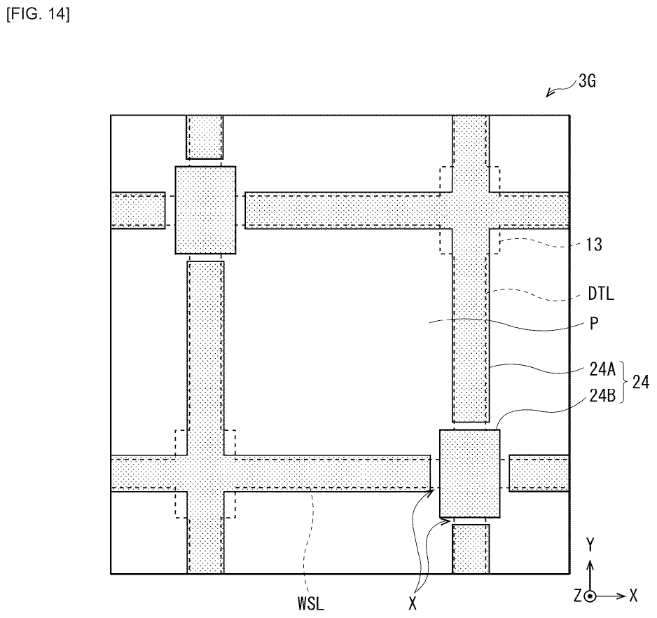

In addition, in a case where the pitch of the pixel P is narrow, a second light-blocking section 25B may be formed in every other manner, for example, as in the liquid crystal display panel 3G illustrated in FIG. 14.

### (2-3. Other Modification Examples)

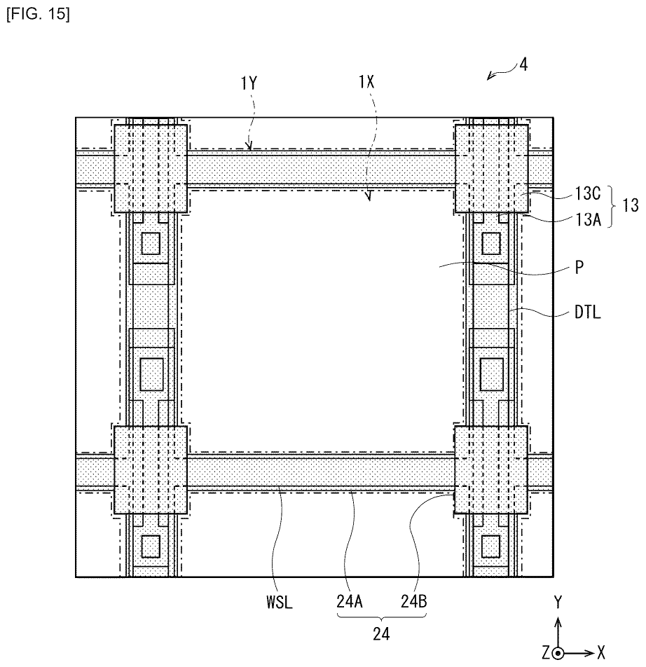

FIG. 15 schematically illustrates an example of a planar configuration of a display apparatus (a liquid crystal display panel 4) according to Modification Example 1 of the present disclosure. In the same manner as the liquid crystal display panel 1 of the foregoing embodiment, the liquid crystal display panel 4 is used, for example, as a light valve (e.g., the spatial light modulators 132A, 132B, and 132C) of the projection display apparatus (projector 100) described later.

In the same manner as the liquid crystal display panel 1 of the foregoing embodiment, the liquid crystal display panel 4 includes the display region 1A in which the plurality of pixel P is two-dimensionally arranged in matrix, and the peripheral region 1B provided therearound. The liquid crystal display panel 4 includes the liquid crystal layer 30 between the drive substrate 10 and the counter substrate 20 which are disposed to be opposed to each other. The counter substrate 20 includes the light-blocking section 24 that covers the plurality of scanning lines WSL, the plurality of signal lines DTL, and the plurality of pixel transistors 13. The plurality of scanning lines WSL and the plurality of signal lines DTL, which intersect each other, and the plurality of pixel transistors 13 are provided in the drive substrate 10, in a plan view. The plurality of pixel transistors 13 is provided at the respective intersecting sections of the plurality of scanning lines WSL and the plurality of signal lines DTL. The light-blocking section 24 includes the first light-blocking section 24A and the second light-blocking section 24B. The first light-blocking section 24A is provided along the plurality of scanning lines WSL and the plurality of signal lines DTL, which intersect each other and are provided in the drive substrate 10. The second light-blocking section 24B that covers the plurality of pixel transistors 13 is provided at respective intersecting sections of the plurality of scanning lines WSL and the plurality of signal lines DTL. The second light-blocking section 24B has a rectangular shape, and is wider than the first light-blocking section 24A.

In general, in a case where the second light-blocking section 24B that covers the pixel transistor 13 includes the overhang section 24X having sides in oblique directions relative to the row direction (X-axis direction) and the column direction (Y-axis direction) as illustrated in FIG. 9, a polarization state may be eliminated at edge parts of the overhang section 24X, thus resulting in a decrease in the contrast in some cases.

In contrast, in the liquid crystal display panel 4 of the present modification example, the second light-blocking section 24B that covers each of the plurality of pixel transistors 13 provided at the respective intersecting sections of the plurality of scanning lines WSL and the plurality of signal lines DTL is allowed to have a rectangular shape coincident with the formation region of the pixel transistor 13. This makes it possible to improve the light resistance without a decrease in the contrast.

The description has been given hereinabove of the present disclosure by referring to the embodiment and Modification Examples 1 to 3; however, the present disclosure is not limited to the foregoing embodiment and the like, and may be modified in a wide variety of ways. For example, the light-blocking section 24 and the projector 100 of the present disclosure are not limited to the configurations described in the foregoing embodiment and the like.

For example, the configurations of the respective light-blocking sections 24 mentioned in the foregoing Modification Examples 1 to 3 may be combined with one another. For example, the coupling section 24C of Modification Example 1 that couples the first light-blocking section 24A and the second light-blocking section 24B to each other is also applicable to the light-blocking section 24 of Modification Example 2 illustrated in FIGS. 8 to 14. This enables the liquid crystal display panels 3A to 3G described in Modification Example 2 to obtain effects similar to those of Modification Example 1.

In addition, the foregoing embodiment exemplifies the projector 100 of a so-called three-panel system including the three liquid crystal panels (spatial light modulators 132A, 132B, and 132C); however, this is not limitative. The present technology is also applicable, for example, to a projection display apparatus of a so-called two-panel system including two liquid crystal panels or a projection display apparatus of a single-panel system.

Further, the foregoing embodiment has exemplified the projector 100 of a reflective type; however, this is not limitative. The present technology is also applicable, for example, to a projection display apparatus of a transmissive type, thus making it possible to obtain similar effects.

Furthermore, the display apparatus of the present disclosure is also applicable to various display apparatuses of a type that displays a picture using a projection lens by modulating light from a light source via a liquid crystal display panel (e.g., the liquid crystal display panel 1 (spatial light modulators 132A, 132B, and 132C)). For example, the display apparatus of the present disclosure is applicable to a head-up display, an Augmented Reality (AR) glass, or the like, in addition to the projector (a projection display apparatus 5) described above.

It is to be noted that the effects described herein are merely exemplary and are not limitative, and may further include other effects.

The present technology may may also have the following configurations. According to the present technology of the following configurations, it is possible to improve the light resistance without a decrease in the contrast.

(1)

A display apparatus including:
a liquid crystal layer;
a first substrate including a plurality of scanning lines and a plurality of signal lines that intersect each other, and a plurality of pixel transistors provided at respective intersecting sections of the plurality of scanning lines and the plurality of signal lines; and
a second substrate disposed to be opposed to the first substrate with the liquid crystal layer interposed therebetween, the second substrate including a first light-blocking section and a second light-blocking section, the first light-blocking section being provided along at least one of the plurality of scanning lines and the plurality of signal lines in a plan view, the second light-blocking section covering at least a portion of each of the plurality of pixel transistors, the second light-blocking section having a substantially rectangular shape and being wider than the first light-blocking section, in which
a slit is provided between the first light-blocking section and the second light-blocking section.
   (2)

The display apparatus according to (1), in which the first light-blocking section is provided along the plurality of scanning lines and the plurality of signal lines.

(3)

The display apparatus according to (1) or (2), in which the second light-blocking section covers an entire surface of each of the pixel transistors in a plan view.

(4)

The display apparatus according to (3), in which the second light-blocking section is coincident with a formation region of each of the pixel transistors in a plan view.

(5)

The display apparatus according to (3), in which the second light-blocking section overhangs, relative to a formation region of each of the pixel transistors, in an extending direction of the plurality of scanning lines or in an extending direction of the plurality of signal lines, in a plan view.

(6)

The display apparatus according to any one of (1) to (5), in which the first light-blocking section and the second light-blocking section are coupled to each other by a coupling section having a width less than ½ of a width of the first light-blocking section.

(7)

The display apparatus according to (6), in which the coupling section is longer than ¼ of the width of the first light-blocking section.

(8)

The display apparatus according to any one of (1) to (7), in which the second light-blocking section is provided for each of the plurality of pixel transistors.

(9)

The display apparatus according to any one of (1) to (8), in which the second light-blocking section is provided in every other manner for the plurality of pixel transistors.

(10)

A display apparatus including:
a liquid crystal layer;
a first substrate including a plurality of scanning lines and a plurality of signal lines that intersect each other, and a plurality of pixel transistors provided at respective intersecting sections of the plurality of scanning lines and the plurality of signal lines; and
a second substrate disposed to be opposed to the first substrate with the liquid crystal layer interposed therebetween, the second substrate including a first light-blocking section and a second light-blocking section, the first light-blocking section covering at least one of the plurality of scanning lines and the plurality of signal lines in a plan view, the second light-blocking section covering at least a portion of each of the plurality of pixel transistors, the second light-blocking section having a substantially rectangular shape and being wider than the first light-blocking section.

The present application claims the benefit of Japanese Priority Patent Application JP2023-048874 filed with the Japan Patent Office on Mar. 24, 2023, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A display apparatus comprising:
a liquid crystal layer;
a first substrate including a plurality of scanning lines and a plurality of signal lines that intersect each other, and a plurality of pixel transistors provided at respective intersecting sections of the plurality of scanning lines and the plurality of signal lines; and
a second substrate disposed to be opposed to the first substrate with the liquid crystal layer interposed therebetween, the second substrate including a first light-blocking section and a second light-blocking section, the first light-blocking section being provided along at least one of the plurality of scanning lines and the plurality of signal lines in a plan view, the second light-blocking section covering at least a portion of each of the plurality of pixel transistors, the second light-blocking section having a substantially rectangular shape and being wider than the first light-blocking section, wherein
a slit is provided between the first light-blocking section and the second light-blocking section.

2. The display apparatus according to claim 1, wherein the first light-blocking section is provided along the plurality of scanning lines and the plurality of signal lines.

3. The display apparatus according to claim 1, wherein the second light-blocking section covers an entire surface of each of the pixel transistors in a plan view.

4. The display apparatus according to claim 3, wherein the second light-blocking section is coincident with a formation region of each of the pixel transistors in a plan view.

5. The display apparatus according to claim 3, wherein the second light-blocking section overhangs, relative to a formation region of each of the pixel transistors, in an extending direction of the plurality of scanning lines or in an extending direction of the plurality of signal lines, in a plan view.

6. The display apparatus according to claim 1, wherein the first light-blocking section and the second light-blocking section are coupled to each other by a coupling section having a width less than ½ of a width of the first light-blocking section.

7. The display apparatus according to claim 6, wherein the coupling section is longer than ¼ of the width of the first light-blocking section.

8. The display apparatus according to claim 1, wherein the second light-blocking section is provided for each of the plurality of pixel transistors.

9. The display apparatus according to claim 1, wherein the second light-blocking section is provided in every other manner for the plurality of pixel transistors.

10. A display apparatus comprising:
a liquid crystal layer;
a first substrate including a plurality of scanning lines and a plurality of signal lines that intersect each other, and a plurality of pixel transistors provided at respective intersecting sections of the plurality of scanning lines and the plurality of signal lines; and
a second substrate disposed to be opposed to the first substrate with the liquid crystal layer interposed therebetween, the second substrate including a first light-blocking section and a second light-blocking section, the first light-blocking section covering at least one of the plurality of scanning lines and the plurality of signal lines in a plan view, the second light-blocking section covering at least a portion of each of the plurality of pixel transistors, the second light-blocking section having a substantially rectangular shape and being wider than the first light-blocking section.
